(19) United States
(12) Patent Application Publication
(10) Pub. No.: US 2026/0009100 A1
(43) Pub. Date: Jan. 8, 2026

(54) BENEFICIATION METHOD FOR IMPROVING GRADE OF MAGNESIUM-CONTAINING COPPER SULFIDE ORE CONCENTRATE

(71) Applicants: KUNMING METALLURGICAL RESEARCH INSTITUTE CO., LTD., Kunming (CN); MINERA CHINALCO PERU S.A., Lima (PE)

(72) Inventors: Jing ZHANG, Kunming (CN); Haijun WU, Kunming (CN); Sheng JIAN, Kunming (CN); Xin TANG, Kunming (CN); Meihua LIU, Kunming (CN); Feng XIE, Kunming (CN); Dong YANG, Kunming (CN); Xiaoguang YU, Kunming (CN); Tengfei LI, Kunming (CN); Shuguang ZHANG, Kunming (CN); Shaodong WANG, Kunming (CN); Xiangwen LV, Kunming (CN); Lin ZHANG, Kunming (CN); Ruoyu YANG, Kunming (CN)

(73) Assignees: KUNMING METALLURGICAL RESEARCH INSTITUTE CO., LTD., Kunming (CN); MINERA CHINALCO PERU S.A., LIma (PE)

(21) Appl. No.: 19/133,749

(22) PCT Filed: Aug. 30, 2023
(86) PCT No.: PCT/CN2023/115920

§ 371 Date: May 29, 2025

(30) Foreign Application Priority Data
Jun. 8, 2023 (CN) 202310677207.1

(51) Int. Cl. C22B 1/00; B03B 9/00; C22B 1/24

(52) U.S. Cl. CPC C22B 1/00; B03B 9/00; C22B 1/24

(57) ABSTRACT

A beneficiation method for improving a grade of a magnesium-containing copper sulfide ore concentrate includes: crushing and grinding an ore to a fineness degree allowing 55% to 65% of particles to pass through a 0.074 mm sieve, adding an adjusting agent lime, collecting agents butylxanthate and kerosene, and a foaming agent methyl isobutyl carbinol (MIBC) to obtain a copper-molybdenum-sulfur mixed concentrate; re-grinding the copper-molybdenum-sulfur mixed concentrate to a fineness degree allowing 75% to 82% of particles to pass through a 0.048 mm sieve, adding lime, a magnesium-containing silicate inhibitor, a collecting agent 1, and MIBC to obtain a copper-molybdenum mixed concentrate; and adding sodium sulfide, kerosene, and MIBC to the copper-molybdenum mixed concentrate to obtain a high-grade copper concentrate. The beneficiation method adopts mixed flotation of copper-molybdenum, regrinding for separating copper and molybdenum from sulfur, and magnesium removal from a copper concentrate to allow quality improvement for the copper concentrate.

### CROSS REFERENCE TO THE RELATED APPLICATIONS

This application is the national phase entry of International Application No. PCT/CN2023/115920, filed on Aug. 30, 2023, which is based upon and claims priority to Chinese Patent Application No. 202310677207.1, filed on Jun. 8, 2023, the entire contents of which are incorporated herein by reference.

### TECHNICAL FIELD

The present disclosure belongs to the field of chemical technologies, and specifically relates to a beneficiation method for improving a grade of a magnesium-containing copper sulfide ore concentrate.

### BACKGROUND

There are generally five types of copper deposits: porphyry copper deposits, skarn copper deposits, stratiform copper deposits, volcanic-sedimentary copper deposits, and nickel-copper sulfide copper deposits. Generally, with the increase of a mining depth, alteration will occur at peripheries of some deposits, such as potash feldspathization, sericitization, silicification, chloritization, or the like. Diversified alteration types increase the difficulty of ore separation, for example, magnesium-containing silicate minerals such as tale, serpentine, and chlorite^{[2]} and pyrites will greatly affect a grade of a copper concentrate.

There are mainly two aspects that affect a grade of a copper concentrate obtained during flotation of a magnesium-containing copper sulfide ore. 1. Influence of magnesium-containing silicate minerals: It is difficult to inhibit magnesium-containing silicate minerals such as talc, serpentine, and chlorite due to their strong hydrophobicity and excellent natural floatability. Magnesium-containing silicate minerals themselves are easily ground and argillized to produce a mineral slime covering a surface of a mineral, which affects the adsorption of a collecting agent for the mineral. In addition, a mineral slime is easily included mechanically by a flotation foam, which affects a grade of a concentrate. 2. Influence of pyrites: Pyrites have excellent floatability and are easy to float. Pyrites are usually inhibited in a high-pH slurry environment, but a foam is easy to entrain other minerals due to stickiness, which affects a quality of a copper concentrate. Pyrites can be activated by Cu²⁺, and chalcopyrite can be inhibited by Fe²⁺, resulting in difficult copper-sulfur separation. Therefore, it is very necessary to develop a method that can solve the above technical problems.

### SUMMARY

An objective of the present disclosure is to provide a beneficiation method for improving a grade of a magnesium-containing copper sulfide ore concentrate.

The objective of the present disclosure is allowed as follows: A beneficiation method for improving a grade of a magnesium-containing copper sulfide ore concentrate is provided, including a pretreatment, a rough selection, a copper-molybdenum/sulfur separation, and a copper concentrate grade improvement, and specifically including:
A, the pretreatment: grinding a raw ore and adjusting a pH to 8.5 to 10 to obtain a material a, where a fineness degree achieved by the grinding allows 55% to 65% of particles to pass through a 0.074 mm sieve;
B, the rough selection: adjusting a concentration of the material a to 30% to 40%; adding a collecting agent and diesel oil and stirring for 2 min to 4 min; adding a foaming agent and stirring for 1 min to 3 min; and conducting aeration and foam scraping for 3 min to 5 min to obtain a flotation foam product, which is a crude mixed concentrate b;
C, the copper-molybdenum/sulfur separation:
1) grinding the crude mixed concentrate b and adjusting a pH to 9 to 10 to obtain a material c, where a fineness degree achieved by the grinding allows 75% to 82% of particles to pass through a 0.048 mm sieve; and
2) adjusting a concentration of the material c to 30% to 40%; adding a magnesium-containing silicate inhibitor and stirring for 2 min to 4 min; adding a collecting agent SG-1 and stirring for 2 min to 4 min; adding the foaming agent and stirring for 1 min to 3 min; and conducting aeration and foam scraping for 2 min to 4 min to obtain a flotation foam product, which is a crude copper-molybdenum mixed concentrate d; and
D, the copper concentrate grade improvement: adding sodium sulfide to the crude copper-molybdenum mixed concentrate d and stirring for 2 min to 4 min; adding the diesel oil and stirring for 1 min to 3 min; adding the foaming agent and stirring for 1 min to 3 min; and conducting aeration and foam scraping for 3 min to 5 min to obtain a magnesium and molybdenum-containing product e and a high-grade copper concentrate f, where the magnesium and molybdenum-containing product e is a flotation foam product.

Specific operations are as follows:
1. The raw ore and water are added to a rod grinding machine according to a solid-to-liquid ratio of 1:1 and then ground to a fineness degree allowing 55% to 65% of particles to pass through a 0.074 mm sieve, and then an adjusting agent lime is added to the rod grinding machine to obtain a flotation slurry sample with a pH of 8.5 to 10.
2. The flotation slurry sample is placed in a flotation machine, and a concentration of the flotation slurry sample is adjusted to 30% to 40%; followed by adding a collecting agent butylxanthate and diesel oil and stirring for 3 min, and adding a foaming agent methyl isobutyl carbinol (MIBC) and stirring for 2 min; and aeration and foam scraping is conducted for 4 min to obtain a flotation foam product, which is a crude mixed concentrate.
3. The crude mixed concentrate with a liquid-to-solid ratio of 1:1 is poured into a grinding machine and then ground to a fineness degree allowing 75% to 82% of particles to pass through a 0.048 mm sieve, and then an adjusting agent lime is added to the grinding machine to obtain a flotation slurry sample with a pH of 9 to 10.
4. The flotation slurry sample is placed in a flotation machine, and a concentration of the flotation slurry sample is adjusted to 30% to 40%; followed by adding a magnesium-containing silicate inhibitor and stirring for 3 min, adding a collecting agent SG-1 and stirring for 3 min, and adding the foaming agent MIBC and stirring for 2 min; and aeration and foam scraping is conducted for 3 min to obtain a flotation foam product, which is a crude copper-molybdenum mixed concentrate.
5. The collecting agent SG-1 is a combination of allyl isobutylxanthate (50% to 65%), glycerol monolaurate (GML) (10% to 20%), and isopropyl alcohol (IPA) (5% to 20%).
6. The magnesium-containing silicate inhibitor is a combination of an inorganic matter and an organic matter in 1:1, where the inorganic matter is at least one of sodium sulfite, sodium hexametaphosphate (SHMP), and water glass and the organic matter is at least one of sodium carboxymethyl cellulose (CMC-Na), a starch, and dextrin.
7. The crude copper-molybdenum mixed concentrate is placed in a flotation machine, and a concentration of the crude copper-molybdenum mixed concentrate is adjusted to 20% to 30%; followed by adding an inhibitor sodium sulfide and stirring for 3 min, and adding the foaming agent MIBC and stirring for 1 min, and aeration and foam scraping is conducted for 3 min, and a product at a bottom of the flotation machine is filtered to obtain a copper concentrate with an improved grade, where a magnesium and molybdenum-containing product is also produced as a flotation foam product.

The present disclosure adopts mixed flotation, regrinding for copper/sulfur separation, copper-molybdenum/talc separation, and coordination of reagents with a process to allow grade improvement for a copper concentrate, which is of reference significance for treatment of an ore of the same type.

The technical principle of the present disclosure has the following characteristics:
1. In the present disclosure, a magnesium-containing silicate inhibitor is added at the copper-molybdenum/sulfur separation stage to further reduce a magnesium content, thereby weakening an impact of a high magnesium content on process stability during a cycling process.
2. In the present disclosure, a collecting agent with strong selectivity is added at the copper-molybdenum/sulfur separation stage to reduce a sulfur content and an impact of some impurities, thereby creating a favorable production environment for copper/molybdenum-magnesium separation.
3. In the present disclosure, a collecting agent with strong collecting ability and weak selectivity is added at the rough selection stage to recover recyclable metals as much as possible and reduce a loss of copper at the rough selection stage. In the present disclosure, a collecting agent with strong selectivity is added at the copper-molybdenum/sulfur separation stage to further reduce an impact of an impurity content.

### BRIEF DESCRIPTION OF THE DRAWINGS

FIG. 1 is a schematic flow chart of the closed-circuit test in Example 1 of the present disclosure; and

FIG. 2 is a schematic flow chart of the full open-circuit test in Example 2 of the present disclosure.

### DETAILED DESCRIPTION OF THE EMBODIMENTS

The present disclosure is further described below in conjunction with embodiments, but is not limited thereto. Any transformation or replacement made based on the teachings of the present disclosure falls within the protection scope of the present disclosure.

The present disclosure provides a beneficiation method for improving a grade of a magnesium-containing copper sulfide ore concentrate, including a pretreatment, a rough selection, a copper-molybdenum/sulfur separation, and a copper concentrate grade improvement, and specifically including:
A, the pretreatment: a raw ore is ground and a pH is adjusted to 8.5 to 10 to obtain a material a, where a fineness degree achieved by the grinding allows 55% to 65% of particles to pass through a 0.074 mm sieve;
B, the rough selection: a concentration of the material a is adjusted to 30% to 40%; followed by adding a collecting agent and diesel oil and stirring for 2 min to 4 min, and adding a foaming agent and stirring for 1 min to 3 min; and aeration and foam scraping is conducted for 3 min to 5 min to obtain a flotation foam product, which is a crude mixed concentrate b;
C, the copper-molybdenum/sulfur separation:
1) the crude mixed concentrate b is ground and a pH is adjusted to 9 to 10 to obtain a material c, where a fineness degree achieved by the grinding allows 75% to 82% of particles to pass through a 0.048 mm sieve; and
2) a concentration of the material c is adjusted to 30% to 40%; followed by adding a magnesium-containing silicate inhibitor and stirring for 2 min to 4 min, adding a collecting agent SG-1 and stirring for 2 min to 4 min, and adding the foaming agent and stirring for 1 min to 3 min; and aeration and foam scraping is conducted for 2 min to 4 min to obtain a flotation foam product, which is a crude copper-molybdenum mixed concentrate d; and
D, the copper concentrate grade improvement: sodium sulfide is added to the crude copper-molybdenum mixed concentrate d and stirred for 2 min to 4 min; followed by adding the diesel oil and stirring for 1 min to 3 min, and adding the foaming agent and stirring for 1 min to 3 min; and aeration and foam scraping is conducted for 3 min to 5 min to obtain a magnesium and molybdenum-containing product e and a high-grade copper concentrate f, where the magnesium and molybdenum-containing product e is a flotation foam product.

In the step A, the pH is adjusted with an adjusting agent lime.

In the step B, the collecting agent is butylxanthate.

In the step B, the foaming agent is MIBC.

In the step 1) of C, the pH is adjusted with the adjusting agent lime.

In the step 2) of C, the magnesium-containing silicate inhibitor includes an inorganic matter and an organic matter.

A mass ratio of the inorganic matter to the organic matter is 1:1.

The inorganic matter is one or more of sodium sulfite, SHMP, and water glass; and the organic matter is one or more of CMC-Na, a starch, and dextrin.

In the step 2) of C, the collecting agent SG-1 includes allyl isobutylxanthate, GML, and IPA.

The allyl isobutylxanthate, the GML, and the IPA are in a mass ratio of (50-65):(10-20):(5-20).

In the step 2) of C, the foaming agent is MIBC.

The present disclosure is further described below with reference to specific examples.

### EXAMPLE 1

Rough selection stage: 3 kg of an ore (copper content: 0.45%, molybdenum content: 0.010%, and magnesium oxide content: 11.81%) was taken and added to a grinding machine, an adjusting agent lime was added to the grinding machine, and the ore was crushed and ground to a fineness degree allowing 65% of particles to pass through a 0.074 mm sieve to obtain a slurry sample with a pH of 9.5; the slurry sample was placed in an 8 L flotation machine, followed by adding butylxanthate and diesel oil (40 g/t and 20 g/t, respectively) and stirring for 3 min, and adding a foaming agent MIBC at an amount of 40 g/t and stirring for 2 min; and aeration and foam scraping was conducted for 4 min to obtain a flotation foam product, which was a crude mixed concentrate.

Copper-molybdenum/sulfur separation stage: A concentration of the copper-molybdenum-sulphur mixed concentrate slurry sample was adjusted to 50%, the adjusting agent lime was added to control a pH at 9, and the copper-molybdenum-sulphur mixed concentrate slurry sample was ground to a fineness degree allowing 75% of particles to pass through a 0.045 mm sieve; the slurry sample after grinding was placed in a 1.5 L flotation machine, followed by adding a magnesium-containing silicate inhibitor at an amount of 300 g/t and stirring for 3 min, adding a collecting agent SG-1 (20 g/t) and stirring for 3 min, and adding the foaming agent MIBC (10 g/t) and stirring for 2 min; and aeration and foam scraping was conducted for 4 min to obtain a flotation foam product, and the flotation foam product was subjected to fine separation once to obtain a copper-molybdenum mixed concentrate.

Copper concentrate grade improvement stage: The copper-molybdenum mixed concentrate slurry sample was placed in a 0.75 L flotation machine, followed by adding sodium sulfide at an amount of 500 g/t and stirring for 3 min, adding diesel oil at an amount of 20 g/t and stirring for 2 min, and adding the foaming agent MIBC (20 g/t) and stirring for 2 min; and aeration and foam scraping was conducted for 4 min, and a resulting slurry product in the flotation machine was subjected to scavenging separation once to obtain a high-grade copper concentrate.

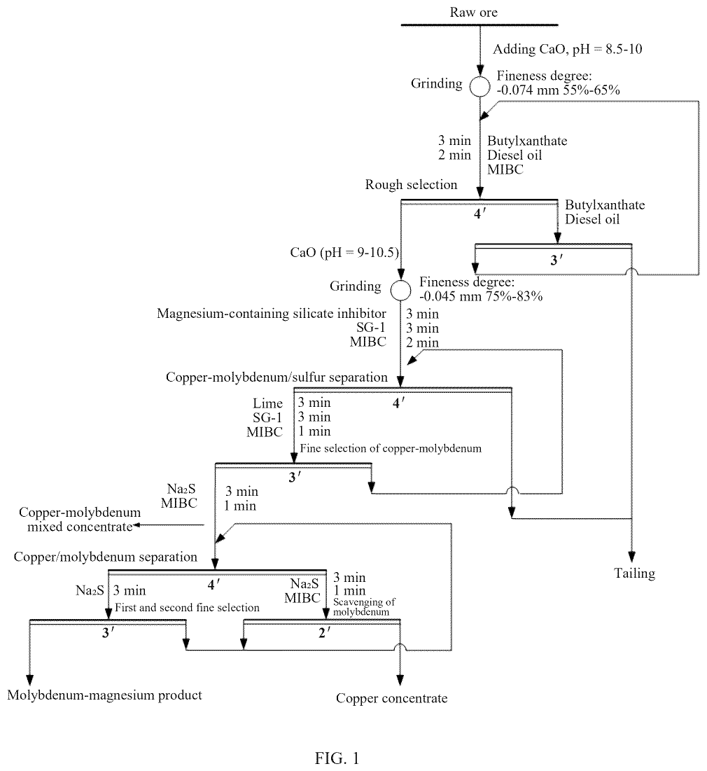

The closed-circuit test in this example was shown in FIG. 1. After an equilibrium value was reached through multiple cycles, two sets of data (as shown in Tables 1 and 2) were taken to analyze a copper grade improvement effect for a copper-molybdenum mixed concentrate, and a copper grade increased by 5% to 6% in the case where a copper recovery rate changed little.

TABLE 1

| Product | | Grade (%) | | | Recovery rate (%) | | |
|---|---|---|---|---|---|---|---|
| name | Yield (%) | Cu | Mo | MgO | Cu | Mo | MgO |
| Molybdenum- | 0.55 | 2.04 | 0.98 | 18.77 | 2.47 | 55.31 | 0.94 |
| magnesium | | | | | | | |
| product | | | | | | | |
| Copper | 1.49 | 24.45 | 0.065 | 3.13 | 80.19 | 9.92 | 0.42 |
| concentrate | | | | | | | |
| Tailing | 97.96 | 0.080 | 0.0035 | 11.080 | 17.34 | 34.77 | 98.64 |
| Raw ore | 100.00 | 0.45 | 0.0098 | 11.00 | 100.00 | 100.00 | 100.00 |
| Copper- | 2.04 | 18.40 | 0.312 | 7.35 | 82.66 | 65.23 | 1.36 |
| molybdenum | | | | | | | |
| mixed | | | | | | | |
| concentrate | | | | | | | |

TABLE 2

| Product | | Grade (%) | | | Recovery rate (%) | | |
|---|---|---|---|---|---|---|---|
| name | Yield (%) | Cu | Mo | MgO | Cu | Mo | MgO |
| Molybdenum- | 0.43 | 1.61 | 0.98 | 21.26 | 1.57 | 49.63 | 0.82 |
| magnesium | | | | | | | |
| product | | | | | | | |
| Copper | 1.47 | 23.97 | 0.06 | 2.85 | 80.15 | 10.42 | 0.38 |
| concentrate | | | | | | | |
| Tailing | 98.10 | 0.082 | 0.0034 | 11.14 | 18.28 | 39.95 | 98.80 |
| Raw ore | 100.00 | 0.440 | 0.0085 | 11.07 | 100.00 | 100.00 | 100.00 |
| Copper- | 1.90 | 18.92 | 0.31 | 7.35 | 81.72 | 59.74 | 1.20 |
| molybdenum | | | | | | | |
| mixed | | | | | | | |
| concentrate | | | | | | | |

### EXAMPLE 2

Rough selection stage: 3 kg of an ore (copper content: 0.46%, molybdenum content: 0.010%, and magnesium oxide content: 11.81%) was taken and added to a grinding machine, an adjusting agent lime was added to the grinding machine, and the ore was crushed and ground to a fineness degree allowing 65% of particles to pass through a 0.074 mm sieve to obtain a slurry sample with a pH of 8.5; the slurry sample was placed in an 8 L flotation machine, followed by adding butylxanthate and diesel oil (30 g/t and 15 g/t, respectively) and stirring for 3 min, and adding a foaming agent MIBC at an amount of 40 g/t and stirring for 2 min; and aeration and foam scraping was conducted for 4 min to obtain a flotation foam product, which was a crude mixed concentrate.

Copper-molybdenum/sulfur separation stage: A concentration of the copper-molybdenum-sulphur mixed concentrate slurry sample was adjusted to 50%, the adjusting agent lime was added to control a pH at 9, and the copper-molybdenum-sulphur mixed concentrate was ground to a fineness degree allowing 81% of particles to pass through a 0.045 mm sieve; the slurry sample after grinding was placed in a 1.5 L flotation machine, followed by adding a magnesium-containing silicate inhibitor at an amount of 200 g/t and stirring for 3 min, adding a collecting agent SG-1 (10 g/t) and stirring for 3 min, and adding the foaming agent MIBC (10 g/t) and stirring for 2 min; and aeration and foam scraping was conducted for 4 min to obtain a flotation foam product, and the flotation foam product was subjected to fine separation once to obtain a copper-molybdenum mixed concentrate.

Copper concentrate grade improvement stage: The copper-molybdenum mixed concentrate slurry sample was placed in a 0.75 L flotation machine, followed by adding sodium sulfide at an amount of 500 g/t and stirring for 3 min, adding diesel oil at an amount of 20 g/t and stirring for 2 min, and adding the foaming agent MIBC at an amount of 20 g/t and stirring for 2 min; and aeration and foam scraping was conducted for 4 min, and a resulting slurry product in the flotation machine was subjected to scavenging separation once to obtain a high-grade copper concentrate.

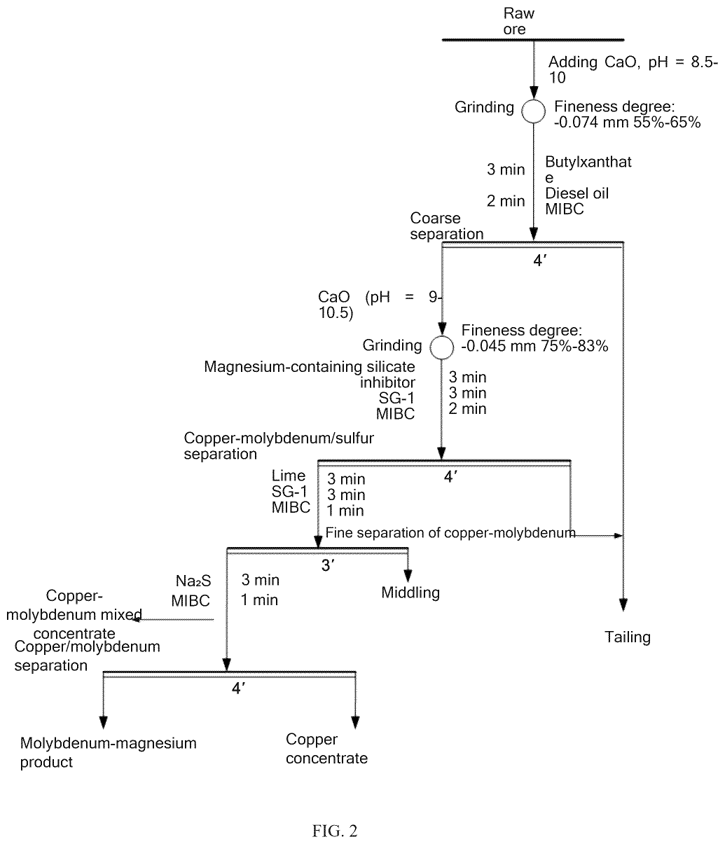

The full open-circuit test in this example was shown in FIG. 2. A copper grade improvement effect for a copper-molybdenum mixed concentrate was analyzed, and a copper grade increased by 5% to 6% in the case where a copper recovery rate changed little. Specific data were shown in Table 3.

TABLE 3

| Product | | Grade (%) | | | Recovery rate (%) | | |
|---|---|---|---|---|---|---|---|
| name | Yield (%) | Cu | Mo | MgO | Cu | Mo | MgO |
| Molybdenum- | 0.34 | 1.05 | 0.50 | 22.28 | 0.77 | 15.90 | 0.64 |
| magnesium | | | | | | | |
| product | | | | | | | |
| Copper | 1.26 | 22.59 | 0.049 | 3.71 | 61.29 | 5.78 | 0.39 |
| concentrate | | | | | | | |
| Middling | 1.20 | 3.35 | 0.15 | 18.57 | 8.66 | 16.84 | 1.87 |
| Tailing | 97.20 | 0.14 | 0.0068 | 11.89 | 6.66 | 61.48 | 97.10 |
| Raw ore | 100.00 | 0.46 | 0.0107 | 11.90 | 100.00 | 100.00 | 100.00 |
| Copper- | 1.60 | 18.01 | 0.14 | 7.66 | 62.06 | 21.68 | 97.10 |
| molybdenum | | | | | | | |
| mixed | | | | | | | |
| concentrate | | | | | | | |

What is claimed is:

1. A beneficiation method for improving a grade of a magnesium-containing copper sulfide ore concentrate, comprising a pretreatment, a rough selection, a copper-molybdenum/sulfur separation, and a copper concentrate grade improvement, and specifically comprising:
A, the pretreatment: grinding a raw ore and adjusting a first pH to 8.5 to 10 to obtain a first material, wherein a fineness degree achieved by the grinding allows 55% to 65% of first particles to pass through a 0.074 mm sieve;
B, the rough selection: adjusting a concentration of the first material to 30% to 40%;
adding a collecting agent and diesel oil and stirring for 2 min to 4 min; adding a foaming agent and stirring for 1 min to 3 min; and conducting aeration and foam scraping for 3 min to 5 min to obtain a first flotation foam product, wherein the first flotation foam product is a crude mixed concentrate;
C, the copper-molybdenum/sulfur separation:
1) grinding the crude mixed concentrate and adjusting a second pH to 9 to 10 to obtain a second material, wherein a fineness degree achieved by the grinding allows 75% to 82% of particles to pass through a 0.048 mm sieve; and
2) adjusting a concentration of the second material to 30% to 40%; adding a magnesium-containing silicate inhibitor and stirring for 2 min to 4 min; adding a collecting agent SG-1 and stirring for 2 min to 4 min; adding the foaming agent and stirring for 1 min to 3 min;
and conducting aeration and foam scraping for 2 min to 4 min to obtain a second flotation foam product, wherein the second flotation foam product is a crude copper-molybdenum mixed concentrate; and
D, the copper concentrate grade improvement: adding sodium sulfide to the crude copper-molybdenum mixed concentrate and stirring for 2 min to 4 min; adding the diesel oil and stirring for 1 min to 3 min; adding the foaming agent and stirring for 1 min to 3 min; and conducting aeration and foam scraping for 3 min to 5 min to obtain a magnesium and molybdenum-containing product and a high-grade copper concentrate, wherein the magnesium and molybdenum-containing product is a third flotation foam product.

2. The beneficiation method for improving the grade of the magnesium-containing copper sulfide ore concentrate according to claim 1, wherein in the step A, the first pH is adjusted with an adjusting agent lime.

3. The beneficiation method for improving the grade of the magnesium-containing copper sulfide ore concentrate according to claim 1, wherein in the step B, the collecting agent is butylxanthate.

4. The beneficiation method for improving the grade of the magnesium-containing copper sulfide ore concentrate according to claim 1, wherein in the step B, the foaming agent is methyl isobutyl carbinol (MIBC).

5. The beneficiation method for improving the grade of the magnesium-containing copper sulfide ore concentrate according to claim 1, wherein in the step 1) of C, the second pH is adjusted with an adjusting agent lime.

6. The beneficiation method for improving the grade of the magnesium-containing copper sulfide ore concentrate according to claim 1, wherein in the step 2) of C, the magnesium-containing silicate inhibitor comprises an inorganic matter and an organic matter.

7. The beneficiation method for improving the grade of the magnesium-containing copper sulfide ore concentrate according to claim 6, wherein a mass ratio of the inorganic matter to the organic matter is 1:1.

8. The beneficiation method for improving the grade of the magnesium-containing copper sulfide ore concentrate according to claim 6, wherein the inorganic matter is one or more of sodium sulfite, sodium hexametaphosphate (SHMP), and water glass; and the organic matter is one or more of sodium carboxymethyl cellulose (CMC-Na), a starch, and dextrin.

9. The beneficiation method for improving the grade of the magnesium-containing copper sulfide ore concentrate according to claim 1, wherein in the step 2 ) of C, the collecting agent SG-1 comprises allyl isobutylxanthate, glycerol monolaurate (GML), and isopropyl alcohol (IPA).

10. The beneficiation method for improving the grade of the magnesium-containing copper sulfide ore concentrate according to claim 9, wherein the allyl isobutylxanthate, the GML, and the IPA are in a mass ratio of (50-65):(10-20):(5-20).

11. The beneficiation method for improving the grade of the magnesium-containing copper sulfide ore concentrate according to claim 7, wherein the inorganic matter is one or more of sodium sulfite, SHMP, and water glass; and the organic matter is one or more of CMC-Na, a starch, and dextrin.
